(19) United States
(12) Patent Application Publication
(10) Pub. No.: US 2020/0383855 A1
(43) Pub. Date: Dec. 10, 2020

(54) Bedside Urinal Apparatus

(71) Applicant: Melvin Drakeford, New York, NY (US)

(72) Inventor: Melvin Drakeford, New York, NY (US)

(21) Appl. No.: 16/436,280

(22) Filed: Jun. 10, 2019

(51) Int. Cl. A61G 9/00; A47K 11/12

(52) U.S. Cl. CPC A61G 9/006; A47K 11/12

(57) ABSTRACT

A bedside urinal apparatus. The apparatus includes a urine receptacle having a base, a perimeter sidewall, and a top wall defining an interior volume. A flexible tube includes a lower end connected to the top wall of the base. The interior volume of the base is in fluid communication with an interior channel of the flexible tube. A urine cup is affixed to an upper end of the flexible tube. The urine cup includes a base and a perimeter wall defining an interior volume in fluid communication with the interior channel of the tube. A cup holder is disposed on an upper end of a vertical support that extends upwardly from the base. The cup holder is configured to removably secure the urine cup therein. The bedside urinal apparatus can be utilized by an individual who has the need to urinate without leaving the comfort of their bed.

### BACKGROUND OF THE INVENTION

The present invention relates to urinals and urine collection devices. More particularly, the present invention provides a bedside urinal apparatus that includes a urine receptacle, a flexible tube, and a urine cup that is configured to receive urine therein, such that urine is received in the receptacle and stored until it is later emptied. The present invention is particularly designed so that a user can utilize the present invention to urinate while lying in bed.

Many individuals have the urge to urinate at least once during the night while sleeping. Most of these individuals must get up out of bed and walk to a bathroom to urinate. In unfamiliar settings, it can be difficult for the individual to navigate and locate the bathroom, particularly at night when it is dark. Further, the act of urinating is disruptive to the individual's sleep cycle, and the act of walking back and forth from the bathroom can cause the individual to remain awake and not fall back asleep. For individuals who share their bed with a partner, the act of rising from bed to go to the bathroom can wake their sleeping partner, who may then find it difficult to fall back to sleep. Rather than getting up to urinate in a bathroom, an individual may instead choose to hold it in until morning. This can potentially damage the individual's bladder or other internal organs, and may further result in a bedwetting accident due to leakage which soils the user's sleeping garments, sheets, covers, and other parts of the bed.

For individuals with physical disabilities or otherwise limited mobility, it can be difficult to get out of bed and go to the restroom to urinate. Some individuals may require the assistance of another to leave the bed to use the bathroom, but other individuals may not always be present to help with leaving the bed. Often, a bed pan is used for individuals that cannot leave the bed to urinate. However, these can be unsanitary and difficult to clean, as well as bulky and unwieldy. It can also be difficult to retrieve and position a bed pan properly, especially at night when the room occupied by the user is typically dark. In view of the above concerns, it is desirable to provide a bedside urinal apparatus that can be utilized by an individual to receive and store urine, such that the user can easily access and use the apparatus while laying in bed, eliminating the need for the user to rise from the bed and walk to the bathroom to relieve themselves.

Devices have been disclosed in the known art that relate to urinals and urine collection devices. These include devices that have been patented and disclosed in patent application publications. However, the devices in the known art have several drawbacks. Many of these devices do not provide an extra support for the urine collector, meaning they are difficult to handle and use properly. Additionally, many devices in the known art do not include a handle to facility with use of the device. Further, these devices fail to provide a urine collection apparatus that includes a urine cup having a handle extending outwardly and downwardly therefrom to facilitate ease of use, as well as a vertical support rod extending upwardly from the base and supporting a urine cup holder, such that the urine cup can be stored when the apparatus is not in use in a manner such that the urine cup is easily accessible to an individual laying in a bed adjacent to the apparatus.

In light of the devices disclosed in the known art, it is submitted that the present invention substantially diverges in design elements from the known art and consequently it is clear that there is a need in the art for an improvement to existing urine collection devices. In this regard the present invention substantially fulfills these needs.

### SUMMARY OF THE INVENTION

In view of the foregoing disadvantages inherent in the known types of urinals and urine collection devices now present in the prior art, the present invention provides a bedside urinal apparatus wherein the same can be utilized for providing convenience for the user when having to urinate while still remaining in bed. The present system comprises a urine receptacle having a base, a perimeter sidewall extending upwardly therefrom, and a top wall defining an interior volume. The system further comprises a flexible tube having a lower end connected to the top wall of the base, wherein the interior volume of the base is in fluid communication with an interior channel of the flexible tube. A urine cup is affixed to an upper end of the flexible tube, wherein the urine cup includes a base and a perimeter wall defining an interior volume that is in fluid communication with the interior channel of the tube. A vertical support includes a lower end affixed to the base and an upper end having a cup holder affixed thereto. The cup holder is configured to removably secure the urine cup therein.

One object of the present invention is to provide a beside urinal apparatus that has all of the advantages and none of the disadvantages of urine collection devices that are known in the art.

Another object of the present invention is to provide a bedside urinal apparatus that allows the user to easily urinate while still lying in bed, eliminating the need for the user to get up and go to the bathroom to urinate.

A further object of the present invention to provide a bedside urinal apparatus that is easy and inexpensive to manufacture and can be made from readily available materials.

Yet another object of the present invention is to provide a bedside urinal apparatus having a urine collection cup that is specifically adapted to receive the penis of the user therein.

An additional object of the present invention is to provide a bedside urinal apparatus that can be positioned closely next to a bed or other support surface, so that the user can easily access and use the apparatus when needed while still lying in bed.

Still a further object of the present invention is to provide a bedside urinal apparatus having a cup holder that allows the urine collection cup to be stored in a location that is close to the user for easy access.

Still an additional object of the present invention is to provide a bedside urinal apparatus that can be utilized by caregivers in nursing homes and hospitals in order to assist patients with urination without the patient having to leave their bed.

Another object of the present invention is to provide a bedside urinal apparatus that includes a urine receptacle that is easy to empty and clean as needed.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the bedside urinal apparatus.

FIG. 2 shows a perspective view of the urine cup component of an embodiment of the bedside urinal apparatus.

FIG. 3 shows a perspective view of the bedside urinal apparatus showing the urine cup secured to the cup holder.

FIG. 4 shows a perspective view of the bedside urinal apparatus situated next to a user laying in a bed.

### DETAILED DESCRIPTION OF THE INVENTION

Reference is made herein to the attached drawings. Like reference numerals are used throughout the drawings to depict like or similar elements of the bedside urinal apparatus. For the purposes of presenting a brief and clear description of the present invention, the preferred embodiment will be discussed as used for collecting urine from an individual while the individual is laying in a bed or other elevated support surface. The figures are intended for representative purposes only and should not be considered to be limiting in any respect.

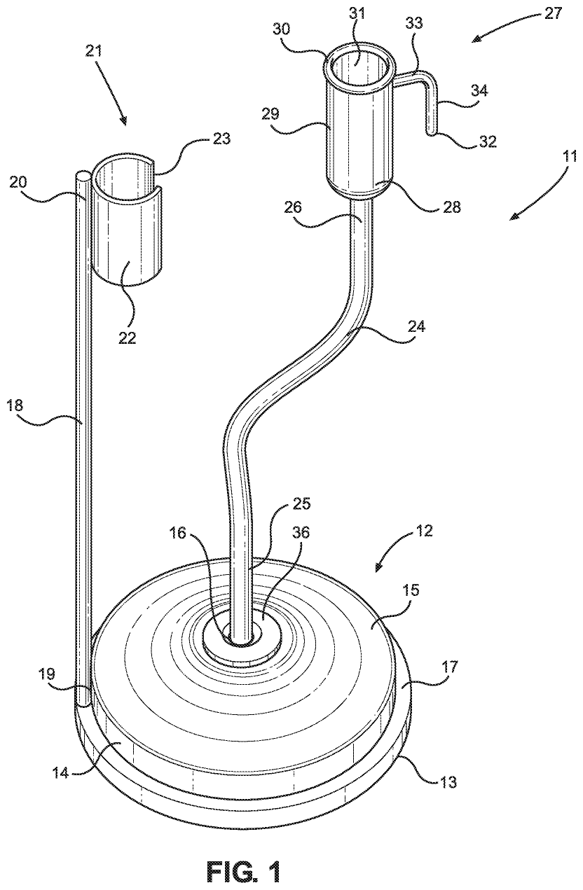

Referring now to FIG. 1, there is shown a perspective view of an embodiment of the bedside urinal apparatus. The bedside urinal apparatus 11 generally includes a urine receptacle 12, a urine cup 27, and a cup holder 21. The urine receptacle 12 is adapted to receive and store urine within its interior volume via a flexible tube 24 that connects the base 28 of the urine cup 27 to the receptacle 12, such that the urine cup 27 is in fluid communication with the receptacle 12.

The urine receptacle 12 includes a base 13, a perimeter sidewall 14 extending upwardly therefrom, and a top wall 15 that together define the receptacle 12 interior volume (not visible). In the illustrated embodiment, the urine receptacle 12 includes a circular shape. However, other embodiments may include different shapes. In the shown embodiment, the base 13 includes a perimeter lip 17 disposed annularly around the base 13. The perimeter lip 17 increases the stability of the base 13 by providing an increased area to its support surface to prevent tipping.

A lower end 25 of a flexible tube 24 is connected to an opening 16 on the top wall 15 of the urine receptacle 12. The flexible tube 24 includes an interior channel (not shown) that is in fluid communication with urine cup 27, such that the interior channel allows urine to flow from the urine cup 27 that is affixed to the upper end 26 of the tube 24 and into the urine receptacle 12. In some embodiments, a disk 36 surrounds the opening 16 and the lower end 25 of the flexible tube 24. In some embodiments, the flexible tube 24 is configured to maintain a shape or configuration to which it is bent, i.e., a gooseneck configuration, such that the urine cup 27 can be positioned in a comfortable way that allows the user to easily insert their penis and urinate while lying in bed.

The urine cup 27 includes a base 28 and a perimeter sidewall 29 extending upwardly therefrom, terminating in an open upper end and defining an interior volume 31. A handle 32 is affixed to the urine cup 27, which allows the user to easily grasp and utilize the urine cup 27. In the shown embodiment, the handle 32 includes a horizontal member 33 extending radially outwardly from the sidewall 29 of the urine cup 27 and a vertical member 34 extending perpendicularly downward from a distal end of the horizontal member 33. In the shown embodiment, the urine cup 27 is contoured and sized to receive the penis of the user within the interior volume 31. In some embodiments, the urine cup 27 includes a perimeter flange 30 disposed annularly around the upper edge of the perimeter sidewall 29 of the urine cup 27. The flange 30 can help to confine urine to the interior volume 31 of the urine cup 27 and prevent accidental spillage during use.

A lower end 19 of a vertical support 18 is affixed to the urine receptacle 12, and a cup holder 21 is affixed to the upper end 20 of the vertical support 18. The cup holder 21 includes a cylindrical sleeve 22 having a slot 23 extending from an upper end of the sleeve 22 to a lower end of the sleeve 22. The slot 23 is configured to receive the handle 32 of the urine cup 27 when the urine cup 27 is removably secured within the cup holder 21, such that the sleeve 22 includes a pair of opposing ends that each terminate at one side of the slot 23. In some embodiments, the opposing ends are biased inwardly toward each other, such that the urine cup 27 can be frictionally secured therebetween when not in use. In the shown embodiment, an outer side of the cup holder 21 is affixed to a side portion of the vertical support 18, which ensures a stable attachment for the cup holder 21. Further, in the shown embodiment, the upper edge of the cup holder 21 is flush with an upper edge of the vertical support 18, which allows the perimeter lip 30 of the cup holder 21 to rest on both the cup holder 21 and the vertical support 18 for additional stability when the cup holder 21 is stored.

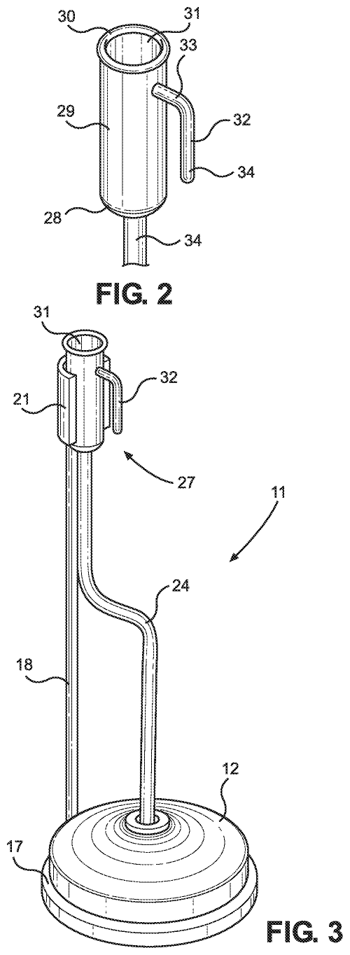

Referring now to FIG. 2, there is shown a perspective view of the urine cup component of an embodiment of the bedside urinal apparatus. In the shown embodiment, the urine cup is particularly designed for male use, in that the base 28 and sidewalls 29 of the urine cup are configured to contour to the shape of a user's penis when inserted into the interior volume 31 of the urine cup. For example, in the shown embodiment, the base 28 includes a continuously curved shape or profile that connects to the tube 24. The base 28 is configured to contour to the shape of the tip of a penis, such that the urine cup can be comfortably used by a male individual. In other embodiments, the urine cup can include alternate shapes or configurations, such that it may be configured for female use or for unisex use.

In the shown embodiment, the handle 32 includes a horizontal member 33 extending radially outwardly from the sidewall 29 of the urine cup 27 and a vertical member 34 extending perpendicularly downward from a distal end of the horizontal member 33. This “L-shape” handle provides an effective grip for users. However, other shapes and configurations of handles may be utilized in other embodiments of the present invention.

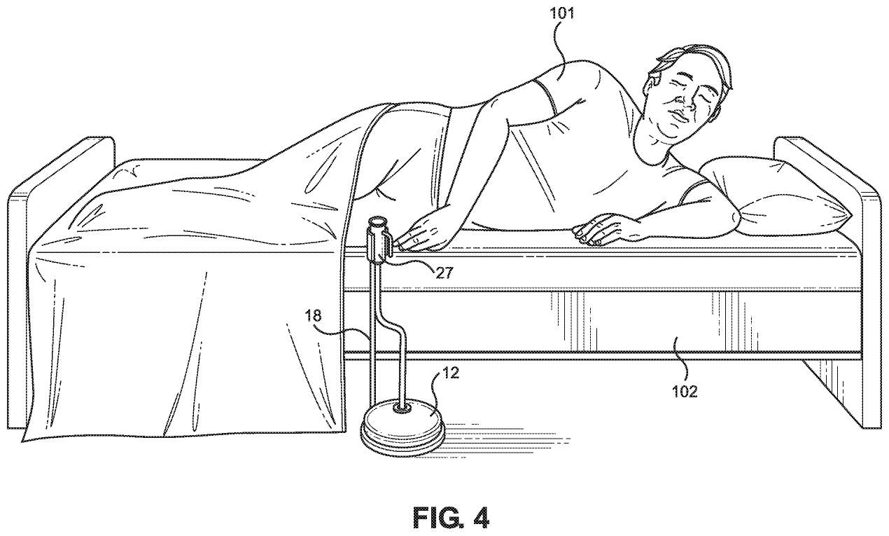

Referring now to FIGS. 3 and 4, there is shown a perspective view of the bedside urinal apparatus showing the urine cup secured to the cup holder and a perspective view of the bedside urinal apparatus situated next to a user laying in a bed, respectively. In the illustrated embodiment, gravity causes urine to flow from the urine cup 27, through the tube 24, and into the urine receptacle 12 for storage. In alternate embodiments, the bedside urinal apparatus 11 may include one or more pumps operably connected to a power supply such as a battery, a wall outlet, or the like. The one or more pumps are configured to assist with transporting urine to the urine receptacle 12 and can be configured to activate automatically when urine is detected or can include a manual control switch.

In operation, the user 101 places the bedside urinal apparatus 11 close to their bed 102 or other elevated surface on which the user typically sleeps, with the urine cup 27 stored within the cup holder 21. When the user needs to urinate, the user 101 can roll over in the bed 102 toward the bedside urinal apparatus 11, grasp the handle 32 and remove the urine cup 27 from the cup holder 21, and insert their penis into the interior volume 31 of the urine cup 27. The user may then urinate into the urine cup 27, whereby the urine travels downwardly through the flexible tube 24 and into the urine receptacle 12. The combination of the weight of the liquid within the receptacle 12 and the perimeter lip 17 prevent the apparatus from being easily tipped over, as the apparatus is given a low center of gravity.

In some embodiments, the urine cup 27 is removably secured to the flexible tube 24, and the flexible tube 24 is removably secured to the urine receptacle 12. In other embodiments, the urine receptacle 12 includes a drain plug disposed on a lower side of the base (not shown) which can be removed from its aperture to allow urine to drain from the urine receptacle 12. In this way, the bedside urinal apparatus 11 can be easily disassembled and cleaned between uses, and then returned to the user's bedside for subsequent uses.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships h e illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A bedside urinal apparatus, comprising:
a urine receptacle having a base, a perimeter sidewall extending upwardly therefrom, and a top wall defining an interior volume;
a flexible tube having a lower end connected to the top wall of the base, wherein the interior volume of the base is in fluid communication with an interior channel of the flexible tube;
a urine cup affixed to an upper end of the flexible tube, the urine cup including a base and a perimeter wall defining an interior volume that is in fluid communication with the interior channel of the tube;
a vertical support including a lower end affixed to the urine receptacle;
a cup holder disposed on an upper end of the vertical support, wherein the cup holder is configured to removably secure the urine cup therein, wherein the cup holder is attached to a side portion of the vertical support for stability, such that an upper edge of the vertical support is aligned with and flush with an upper edge of the cup holder;
a handle affixed to the urine cup.

2) (canceled)

3) The bedside urinal apparatus of claim 1, wherein the handle includes a horizontal member extending radially outwardly from the sidewall of the urine cup and a vertical member extending perpendicularly downward from a distal end of the horizontal member.

4) The bedside urinal apparatus of claim 1, wherein the urine cup includes a perimeter flange disposed annularly around an upper edge of the sidewall of the urine cup.

5) The bedside urinal apparatus of claim 1, wherein the base of urine cup comprises a continuously curved shape.

6) The bedside urinal apparatus of claim 1, wherein an outer side of the cup holder is affixed to a side portion of the vertical support.

7) The bedside urinal apparatus of claim 1, wherein the cup holder comprises a cylindrical sleeve having an elongated slot extending from an upper end of the sleeve to a lower end of the sleeve, such that the sleeve includes a pair of opposing ends that each terminate at one side of the slot.

8) The bedside urinal apparatus of claim 7, wherein the opposing ends of the sleeve are biased inwardly such that the sleeve is configured to frictionally engage and support the urine cup when the urine cup is removably secured therein.

9) (canceled)

10) The bedside urinal apparatus of claim 1, wherein the flexible tube is configured to maintain a particular shape to which it is bent.

11) A bedside urinal apparatus, comprising:
a urine receptacle having a base, a perimeter sidewall extending upwardly therefrom, and a top wall defining an interior volume;
a flexible tube having a lower end connected to the top wall of the base, wherein the interior volume of the base is in fluid communication with an interior channel of the flexible tube;
a urine cup affixed to an upper end of the flexible tube, the urine cup including a base and a perimeter wall defining an interior volume that is in fluid communication with the interior channel of the tube;
a handle affixed to the urine cup, wherein the handle includes a horizontal member extending radially outwardly from the sidewall of the urine cup and a vertical member extending perpendicularly downward from a distal end of the horizontal member;
a vertical support including a lower end affixed to an upper side of a perimeter lip disposed annularly around the base, wherein a side portion of the vertical support contacts the perimeter sidewall of the base;
a cup holder disposed on an upper end of the vertical support, wherein the cup holder is configured to removably secure the urine cup therein, wherein the cup holder is attached to the side portion of the vertical support for stability, such that an upper edge of the vertical support aligns with and is flush with an upper edge of the cup holder.

12) The bedside urinal apparatus of claim 11, further comprising:
a disk disposed on an upper end of the top wall of the urine receptacle, wherein the disk encircles the lower end of the flexible tube.

13) The bedside urinal apparatus of claim 11, wherein the urine cup is removably secured to the upper end of the flexible tube.

14) The bedside urinal apparatus of claim 11, wherein the flexible tube is removably secured to the top wall of the receptacle.

15) The bedside urinal apparatus of claim 11, wherein the base of urine cup comprises a continuously curved shape.

16) (canceled)

17) The bedside urinal apparatus of claim 11, wherein the cup holder comprises a cylindrical sleeve having an elongated slot extending from an upper end of the sleeve to a lower end of the sleeve, such that the sleeve includes a pair of opposing ends that each terminate at one side of the slot.

18) The bedside urinal apparatus of claim 17, wherein the opposing ends of the sleeve are biased inwardly such that the sleeve is configured to frictionally engage and support the urine cup when the urine cup is removably secured therein.

19) The bedside urinal apparatus of claim 17, wherein an upper edge of the cup holder is flush with and upper edge of the vertical support.

20) The bedside urinal apparatus of claim 11, further comprising a drain plug disposed on a lower side of the base.

21) A bedside urinal apparatus, consisting of:
a urine receptacle having a base, a perimeter sidewall extending upwardly therefrom, and a top wall defining an interior volume;
a flexible tube having a lower end connected to the top wall of the base, wherein the interior volume of the base is in fluid communication with an interior channel of the flexible tube;
a urine cup affixed to an upper end of the flexible tube, the urine cup including a base and a perimeter wall defining an interior volume that is in fluid communication with the interior channel of the tube;
a vertical support including a lower end affixed to the urine receptacle;
a cup holder disposed on an upper end of the vertical support, wherein the cup holder is configured to removably secure the urine cup therein.
